(19) United States
(12) Patent Application Publication
(10) Pub. No.: US 2015/0268410 A1
(43) Pub. Date: Sep. 24, 2015

(54) LIQUID CRYSTAL DISPLAY DEVICE

(71) Applicant: Shenzhen China Star Optoelectronics Technology Co. Ltd., Shenzhen, Guangdong (CN)

(72) Inventor: Gang Yu, Shenzhen (CN)

(73) Assignee: Shenzhen China Star Optoelectronics Tehcnology Co. Ltd., Shenzhen, Guangdong (CN)

(21) Appl. No.: 14/349,330

(22) PCT Filed: Jan. 22, 2014
(86) PCT No.: PCT/CN2014/071150

§ 371 Date: Apr. 2, 2014

(30) Foreign Application Priority Data
Dec. 27, 2013 (CN) 201310733613.1

(51) Int. Cl. F21V 8/00; G02F 1/1333

(52) U.S. Cl. CPC G02B 6/0083; G02F 1/133308; G02F 1/133345; G02B 6/0073; G02B 6/0068; G02B 6/0085; G02F 2001/13332

(57) ABSTRACT

The present invention provides a liquid crystal display device, which includes: a backlight module (20), a mold frame (40) mounted on the backlight module (20), a liquid crystal display panel (60) mounted in the mold frame (40), and a bezel (80) mounted on the liquid crystal display panel (60). The backlight module (20) includes a backplane (2), a light guide plate (4) arranged in the backplane (2), a backlight source (6) arranged in the backplane (2), and an optical film assembly (8) arranged on the light guide plate (4). The backlight source (6) includes a printed circuit board (62) and a plurality of LED lights (64) mounted to and electrically connected with the printed circuit board (62). The printed circuit board (62) includes a lateral section (622) and a bottom section (624) perpendicularly connected to the lateral section (622). The mold frame (40) includes an opening (42) formed therein to correspond to the backlight source (6). The lateral section (622) of the printed circuit board (62) is received in the opening (42).

### BACKGROUND OF THE INVENTION

1. Field of the Invention

The present invention relates to the field of liquid crystal displaying, and in particular to a liquid crystal display device.

2. The Related Arts

Liquid crystal displays have a variety of advantages, such as thin device body, low power consumption, and being free of radiation, and are thus widely used. Most of the liquid crystal displays that are currently available in the market are backlighting liquid crystal displays, which comprise a liquid crystal display panel and a backlight module. The operation principle of the liquid crystal display panel is that, with liquid crystal molecules interposed between two parallel glass substrates, a number of tiny vertical and horizontal electrical wires are arranged between the two glass substrates to selectively receive application of electricity thereto to control the rotation direction of the liquid crystal molecules in order to refract out light emitting from the backlight module for generating images. Since the liquid crystal display panel itself does not emit light, light must be provided by the backlight module in order to normally display images. Thus, the backlight module is one of the key components of a liquid crystal display. The backlight modules can be classified in two types, namely a side-edge backlight module and a direct backlight module, according to the position where light gets incident. The direct backlight module comprises a light source, such as a cold cathode fluorescent lamp (CCFL) or a light-emitting diode (LED), which is arranged at the backside of the liquid crystal display panel to form a planar light source directly supplied to the liquid crystal display panel. The side-edge backlight module comprises an LED light bar, serving as a backlight source, which is arranged at an edge of a backplane to be located rearward of one side of the liquid crystal panel. The LED light bar emits light that enters a light guide plate (LGP) through a light incident face at one side of the light guide plate and is projected out of a light emergence face of the light guide plate, after being reflected and diffused, to pass through an optic film assembly to form a planar light source for the liquid crystal panel.

The progress of manufacturing techniques of liquid crystal display devices guides the liquid crystal display devices in a direction toward bezel slimming. Referring to FIG. 1, which is a schematic view showing the structure of a conventional slim bezel liquid crystal display device, in the structure, a backlight source 100 comprises a printed circuit board (PCB) 102 positioned on a bottom plate 202 of a backplane 200 and fixed to the bottom plate 202 of the backplane 200 by being fastened by a bolt. The backlight source 100 comprises an LED light 104 that is mounted to the PCB 102 through bonding. The LED light 104 has a back side that is directly positioned against a mold frame 300 in order to realize an arrangement of bezel slimming.

Although a liquid crystal display device having such an arrangement can achieve slimming of the bezel, heat dissipation of the LED light 104 of the backlight source 100 is an issue that cannot be neglected. The LED light 104 is only in contact with the PCB 102 with the bottom end thereof, while the back thereof is directly positioned against the mold frame 300. The mold frame 300 is generally made of plastics, having poor heat dissipation characteristics. Thus, the heat generated by the LED light 104 would be extremely hard to dissipate out and this readily leads to damage of the LED light 104 for a long-term use, thereby reducing the lifespan of the LED light 104. Further, mounting the LED light 104 through bonding would readily lead to inclining of the LED light 104, causing poor contact of the LED light 104, affecting light emission performance, and lowering down the quality of the liquid crystal display device.

### SUMMARY OF THE INVENTION

An object of the present invention is to provide a liquid crystal display device, which has a simple structure, realizes ultra bezel slimming, improves heat dissipation performance of the LED (Light-Emitting Diode) light, and makes the LED light securely mounted without positional shifting to cause poor contact and affect the light emission performance thereby improving the quality of the liquid crystal display device.

To achieve the above object, the present invention provides a liquid crystal display device, which comprises: a backlight module, a mold frame mounted on the backlight module, a liquid crystal display panel mounted in the mold frame, and a bezel mounted on the liquid crystal display panel. The backlight module comprises a backplane, a light guide plate arranged in the backplane, a backlight source arranged in the backplane, and an optical film assembly arranged on the light guide plate. The backlight source comprises a printed circuit board and a plurality of LED lights mounted to and electrically connected with the printed circuit board. The printed circuit board comprises a lateral section and a bottom section perpendicularly connected to the lateral section. The mold frame comprises an opening formed therein to correspond to the backlight source. The lateral section of the printed circuit board is received in the opening.

The lateral section and the bottom section of the printed circuit board are arranged in an L-shaped configuration. The plurality of LED lights is mounted to the lateral section of the printed circuit board.

The lateral section and the bottom section of the printed circuit board are integrally formed together.

The backlight module further comprises a reflector plate arranged between the backplane and the light guide plate.

The backlight source further comprises an insulation layer arranged between the reflector plate and the bottom section of the printed circuit board.

The insulation layer comprises photo solder resist.

The backplane comprises a bottom plate and a plurality of side plates perpendicularly connected to the bottom plate. The bottom plate comprises a first plate and a second plate connected to the first plate. The first plate and the second plate are arranged in a stepped configuration.

The lateral section of the printed circuit board is directly positioned on the side plates of the backplane. The bottom section of the printed circuit board and the insulation layer formed on the bottom section are positioned on the first plate of the backplane.

The mold frame comprises a bearing section and three sidewalls extending downward from the bearing section. The three sidewalls are orderly connected to define the opening.

The backplane is made of metals, the mold frame is made of plastics, and the bezel is made of plastics or metals.

The present invention also provides a liquid crystal display device, which comprises: a backlight module, a mold frame mounted on the backlight module, a liquid crystal display panel mounted in the mold frame, and a bezel mounted on the liquid crystal display panel, the backlight module comprising a backplane, a light guide plate arranged in the backplane, a backlight source arranged in the backplane, and an optical film assembly arranged on the light guide plate, the backlight source comprising a printed circuit board and a plurality of LED lights mounted to and electrically connected with the printed circuit board, the printed circuit board comprising a lateral section and a bottom section perpendicularly connected to the lateral section, the mold frame comprising an opening formed therein to correspond to the backlight source, the lateral section of the printed circuit board being received in the opening;

wherein the lateral section and the bottom section of the printed circuit board are arranged in an L-shaped configuration, the plurality of LED lights being mounted to the lateral section of the printed circuit board;

wherein the lateral section and the bottom section of the printed circuit board are integrally formed together;

wherein the backlight module further comprises a reflector plate arranged between the backplane and the light guide plate;

wherein the backlight source further comprises an insulation layer arranged between the reflector plate and the bottom section of the printed circuit board; and

wherein the insulation layer comprises photo solder resist.

The backplane comprises a bottom plate and a plurality of side plates perpendicularly connected to the bottom plate. The bottom plate comprises a first plate and a second plate connected to the first plate. The first plate and the second plate are arranged in a stepped configuration.

The lateral section of the printed circuit board is directly positioned on the side plates of the backplane. The bottom section of the printed circuit board and the insulation layer formed on the bottom section are positioned on the first plate of the backplane.

The mold frame comprises a bearing section and three sidewalls extending downward from the bearing section. The three sidewalls being orderly connected to define the opening.

The backplane is made of metals, the mold frame is made of plastics, and the bezel is made of plastics or metals.

The efficacy of the present invention is that the present invention provides a liquid crystal display device, which has a simple structure and which comprises a mold frame having a lateral side in which an opening is formed and a printed circuit board that is formed in an L-shaped configuration to be received in the opening so as to achieve ultra slimming of a bezel of a liquid crystal display. Further, the LED lights are mounted to a lateral section of the printed circuit board to achieve improved heat dissipation performance. Further, the LED lights are securely mounted without positional shifting that causes poor contact and affects light emission performance thereby improving the quality of a liquid crystal display device.

For better understanding of the features and technical contents of the present invention, reference will be made to the following detailed description of the present invention and the attached drawings. However, the drawings are provided for the purposes of reference and illustration and are not intended to impose limitations to the present invention.

### BRIEF DESCRIPTION OF THE DRAWINGS

The technical solution, as well as other beneficial advantages, of the present invention will be apparent from the following detailed description of embodiments of the present invention, with reference to the attached drawing. In the drawing:

FIG. 1 is a schematic view showing the structure of a conventional liquid crystal display device;

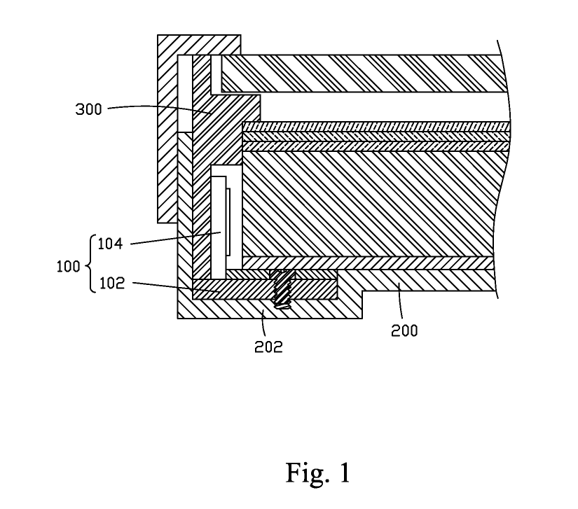

FIG. 2 is a schematic view showing the structure of a liquid crystal display device according to the present invention; and

FIG. 3 is a perspective view showing, in an exploded form, a mold frame and a backlight source of the liquid crystal display device of the present invention.

### DETAILED DESCRIPTION OF THE PREFERRED EMBODIMENTS

To further expound the technical solution adopted in the present invention and the advantages thereof, a detailed description is given to a preferred embodiment of the present invention and the attached drawings.

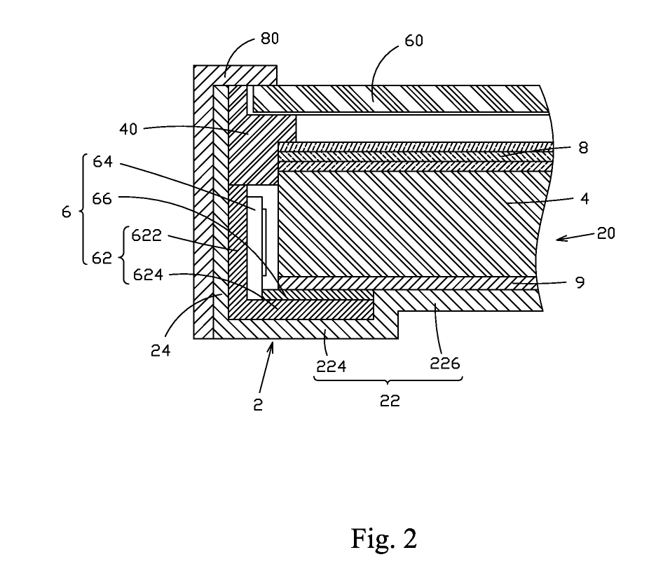

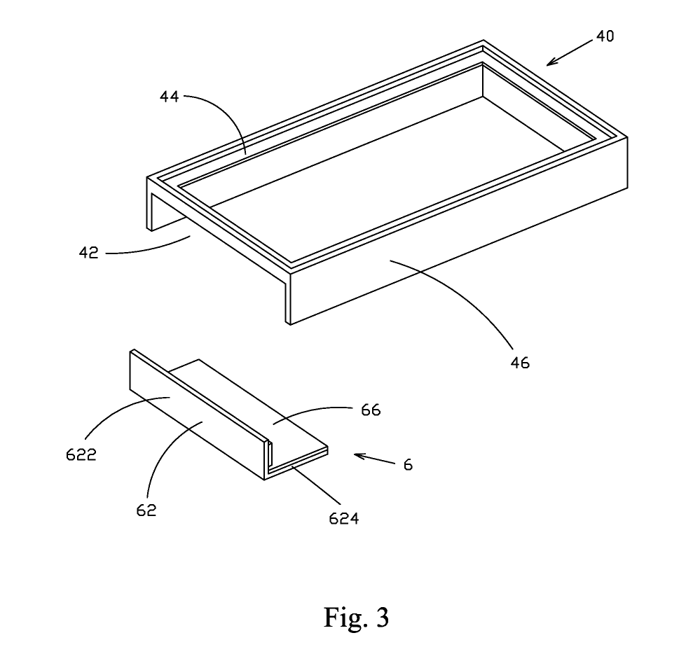

Referring to FIGS. 2 and 3, the present invention provides a liquid crystal display device, which has a simple structure and specifically comprises: a backlight module 20, a mold frame 40 mounted on the backlight module 20, a liquid crystal display panel 60 mounted in the mold frame 40, and a bezel 80 mounted on the liquid crystal display panel 60. The backlight module 20 comprises a backplane 2, a light guide plate 4 arranged in the backplane 2, a backlight source 6 arranged in the backplane 2, and an optical film assembly 8 arranged on the light guide plate 4. The backlight source 6 comprises a printed circuit board 62 and a plurality of LED (Light-Emitting Diode) lights 64 mounted to and electrically connected with the printed circuit board 62. The printed circuit board 62 comprises a lateral section 622 and a bottom section 624 perpendicularly connected to the lateral section 622. The mold frame 40 comprises an opening 42 formed therein to correspond to the backlight source 6. The lateral section 622 of the printed circuit board 62 is received in the opening 42. The lateral section 622 and the bottom section 624 of the printed circuit board 62 are arranged in an L-shaped configuration and the lateral section 622 and the bottom section 624 are integrally formed together.

The backlight module 20 further comprises a reflector plate 9 arranged between the backplane 2 and the light guide plate 4.

The backlight source 6 further comprises an insulation layer 66 arranged between the reflector plate 9 and the bottom section 624 of the printed circuit board 62. The insulation layer 66 is coated on the surface of the bottom section 624 of the printed circuit board 62 that faces the reflector plate 9 for insulating purposes and also for smoothening the surface on which the reflector plate 9 is positioned. In the instant embodiment, the insulation layer 66 comprises photo solder resist (PSR).

The backplane 2 comprises a bottom plate 22 and a plurality of side plates 24 perpendicularly connected to the bottom plate 22. The bottom plate 22 comprises a first plate 224 and a second plate 226 connected to the first plate 224. The first plate 224 and the second plate 226 are arranged in a stepped configuration. The bottom section 624 of the printed circuit board 62 and the insulation layer 66 formed on the bottom section 624 are positioned on the first plate 224 of the bottom plate 22, whereby the light guide plate 4 can be positioned flat on the bottom plate 22 of the backplane 2 and the insulation layer 66 without additional supporting structures.

The backplane 2 is made of a metallic material. The lateral section 622 of the printed circuit board 62 is positioned directly on the side plates 24 of the backplane 2. The plurality of LED lights 64 is mounted on the lateral section 622 of the printed circuit board 62 so that heat of the LED lights 64 can be directly transmitted to the lateral section 622 of the printed circuit board 62 to be then transmitted from the lateral section 622 to the bottom section 624 of the printed circuit board 62 for further transmission to the backplane 2 to achieve efficient dissipation of the heat and thus extending the lifespan of the LED lights 64. Further, the LED lights 64 are mounted on the lateral section 622 of the printed circuit board 62 and the mounting is secure without causing positional shift of the LED lights 64 that leads to poor contact and thus affects light emission performance.

The mold frame 40 comprises a bearing section 44 and three sidewalls 46 extending downward from the bearing section 44. The three sidewalls 46 are orderly connected in such a way to form the opening 42. The lateral section 622 of the printed circuit board 62 that is received in the opening 42 constitutes another lateral side of the mold frame 40 thereby helping achieve ultra slimming of a bezel of a liquid crystal display.

In the instant embodiment, the mold frame 40 is made of plastics and the bearing section 44 thereof functions to bear the liquid crystal display panel 60 thereon. The bezel 80 is made of plastics or metals for retaining and fixing the liquid crystal display panel 60 in the mold frame 40.

In summary, the present invention provides a liquid crystal display device, which has a simple structure and which comprises a mold frame having a lateral side in which an opening is formed and a printed circuit board that is formed in an L-shaped configuration to be received in the opening so as to achieve ultra slimming of a bezel of a liquid crystal display. Further, the LED lights are mounted to a lateral section of the printed circuit board to achieve improved heat dissipation performance. Further, the LED lights are securely mounted without positional shifting that causes poor contact and affects light emission performance thereby improving the quality of a liquid crystal display device.

Based on the description given above, those having ordinary skills of the art may easily contemplate various changes and modifications of the technical solution and technical ideas of the present invention and all these changes and modifications are considered within the protection scope of right for the present invention.

What is claimed is:

1. A liquid crystal display device, comprising: a backlight module, a mold frame mounted on the backlight module, a liquid crystal display panel mounted in the mold frame, and a bezel mounted on the liquid crystal display panel, the backlight module comprising a backplane, a light guide plate arranged in the backplane, a backlight source arranged in the backplane, and an optical film assembly arranged on the light guide plate, the backlight source comprising a printed circuit board and a plurality of LED (Light-Emitting Diode) lights mounted to and electrically connected with the printed circuit board, the printed circuit board comprising a lateral section and a bottom section perpendicularly connected to the lateral section, the mold frame comprising an opening formed therein to correspond to the backlight source, the lateral section of the printed circuit board being received in the opening.

2. The liquid crystal display device as claimed in claim 1, wherein the lateral section and the bottom section of the printed circuit board are arranged in an L-shaped configuration, the plurality of LED lights being mounted to the lateral section of the printed circuit board.

3. The liquid crystal display device as claimed in claim 1, wherein the lateral section and the bottom section of the printed circuit board are integrally formed together.

4. The liquid crystal display device as claimed in claim 1, wherein the backlight module further comprises a reflector plate arranged between the backplane and the light guide plate.

5. The liquid crystal display device as claimed in claim 4, wherein the backlight source further comprises an insulation layer arranged between the reflector plate and the bottom section of the printed circuit board.

6. The liquid crystal display device as claimed in claim 5, wherein the insulation layer comprises photo solder resist.

7. The liquid crystal display device as claimed in claim 1, wherein the backplane comprises a bottom plate and a plurality of side plates perpendicularly connected to the bottom plate, the bottom plate comprising a first plate and a second plate connected to the first plate, the first plate and the second plate being arranged in a stepped configuration.

8. The liquid crystal display device as claimed in claim 7, wherein the lateral section of the printed circuit board is directly positioned on the side plates of the backplane, the bottom section of the printed circuit board and the insulation layer formed on the bottom section being positioned on the first plate of the backplane.

9. The liquid crystal display device as claimed in claim 1, wherein the mold frame comprises a bearing section and three sidewalls extending downward from the bearing section, the three sidewalls being orderly connected to define the opening.

10. The liquid crystal display device as claimed in claim 7, wherein the backplane is made of metals, the mold frame is made of plastics, and the bezel is made of plastics or metals.

11. A liquid crystal display device, comprising: a backlight module, a mold frame mounted on the backlight module, a liquid crystal display panel mounted in the mold frame, and a bezel mounted on the liquid crystal display panel, the backlight module comprising a backplane, a light guide plate arranged in the backplane, a backlight source arranged in the backplane, and an optical film assembly arranged on the light guide plate, the backlight source comprising a printed circuit board and a plurality of LED (Light-Emitting Diode) lights mounted to and electrically connected with the printed circuit board, the printed circuit board comprising a lateral section and a bottom section perpendicularly connected to the lateral section, the mold frame comprising an opening formed therein to correspond to the backlight source, the lateral section of the printed circuit board being received in the opening;
wherein the lateral section and the bottom section of the printed circuit board are arranged in an L-shaped configuration, the plurality of LED lights being mounted to the lateral section of the printed circuit board;
wherein the lateral section and the bottom section of the printed circuit board are integrally formed together;
wherein the backlight module further comprises a reflector plate arranged between the backplane and the light guide plate;
wherein the backlight source further comprises an insulation layer arranged between the reflector plate and the bottom section of the printed circuit board; and
wherein the insulation layer comprises photo solder resist.

12. The liquid crystal display device as claimed in claim 11, wherein the backplane comprises a bottom plate and a plurality of side plates perpendicularly connected to the bottom plate, the bottom plate comprising a first plate and a second plate connected to the first plate, the first plate and the second plate being arranged in a stepped configuration.

13. The liquid crystal display device as claimed in claim 12, wherein the lateral section of the printed circuit board is directly positioned on the side plates of the backplane, the bottom section of the printed circuit board and the insulation layer formed on the bottom section being positioned on the first plate of the backplane.

14. The liquid crystal display device as claimed in claim 11, wherein the mold frame comprises a bearing section and three sidewalls extending downward from the bearing section, the three sidewalls being orderly connected to define the opening.

15. The liquid crystal display device as claimed in claim 12, wherein the backplane is made of metals, the mold frame is made of plastics, and the bezel is made of plastics or metals.
